(19) United States
(12) Patent Application Publication
(10) Pub. No.: US 2025/0150470 A1
(43) Pub. Date: May 8, 2025

(54) SECURITY METHOD AND SECURITY DEVICE

(71) Applicant: Panasonic Automotive Systems Co., Ltd., Kanagawa (JP)

(72) Inventors: Junichi YOSHIDA, Kanagawa (JP); Jun HIDAKA, Kanagawa (JP); Hideyo FUKUSHIMA, Kanagawa (JP); Eiyoshi NAKATSUJI, Kanagawa (JP); Masato ASANUMA, Fukuoka (JP)

(73) Assignee: Panasonic Automotive Systems Co., Ltd., Kanagawa (JP)

(21) Appl. No.: 19/012,038

(22) Filed: Jan. 7, 2025

Related U.S. Application Data
(63) Continuation of application No. PCT/JP2023/032837, filed on Sep. 8, 2023.

(30) Foreign Application Priority Data
Dec. 8, 2022 (JP) 2022-196075

(51) Int. Cl. H04L 9/40

(52) U.S. Cl. CPC H04L 63/1416; H04L 63/1425; H04L 63/1466

(57) ABSTRACT

A security method according to an aspect of the present disclosure includes: obtaining anomaly information on an anomaly caused by an attack on a vehicle calculator that is connected to an in-vehicle communication network in a vehicle and controls the vehicle; and causing, based on the anomaly information obtained, the vehicle calculator to delete, from data stored in a storage of the vehicle calculator, added data that is added in the storage after a predetermined timing.

### CROSS REFERENCE TO RELATED APPLICATIONS

This is a continuation application of PCT International Patent Application No. PCT/JP2023/032837 filed on Sep. 8, 2023, designating the United States of America, which is based on and claims priority of Japanese Patent Application No. 2022-196075 filed on Dec. 8, 2022.

### FIELD

The present disclosure relates to a security method and a security device.

### BACKGROUND

In the related art, there are systems which provide security in communication networks such as in-vehicle communication networks.

Patent Literature (PTL) 1 discloses a device which restrains controls of a vehicle according to influences on the controls of the vehicle when an attack against the vehicle is detected.

### CITATION LIST

### Patent Literature

PTL 1: Japanese Unexamined Patent Application Publication No. 2019-75056

### SUMMARY

However, the device disclosed in PTL 1 can be improved upon. In view of this, the present disclosure provides a security method and the like capable of improving upon the above related art. According to an aspect of the present disclosure, a security method includes: obtaining anomaly information on an anomaly caused by an attack on a vehicle calculator, the vehicle calculator being connected to an in-vehicle communication network in a vehicle and controlling the vehicle; and causing the vehicle calculator to delete added data among data stored in a storage of the vehicle calculator, based on the anomaly information obtained, the added data being added in the storage after a predetermined timing.

According to another aspect of the present disclosure, a security device includes: an obtainer that obtains anomaly information on an anomaly caused by an attack on a vehicle calculator, the vehicle calculator being connected to an in-vehicle communication network in a vehicle and controlling the vehicle; and a controller that causes the vehicle calculator to delete added data among data stored in a storage of the vehicle calculator, based on the anomaly information obtained by the obtainer, the added data being added in the storage after a predetermined timing.

The security method and the like according to an aspect of the present disclosure can be improved upon.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating the configuration of a security system according to an embodiment.

FIG. 2 is a block diagram illustrating the configuration of a vehicle calculator according to the embodiment.

FIG. 3 is a block diagram illustrating the configuration of a management server according to the embodiment.

FIG. 4 is a sequence diagram illustrating the procedure of deleting added data in the security system according to the embodiment.

FIG. 5 is a sequence diagram illustrating the procedure of a fundamental countermeasure in the security system according to the embodiment.

FIG. 6 is a flowchart illustrating the procedure of deleting added data in the management server according to the embodiment.

FIG. 7 is a flowchart illustrating the procedure of a fundamental countermeasure in the management server according to the embodiment.

FIG. 8 is a flowchart illustrating a procedure in a security device according to the embodiment.

### DESCRIPTION OF EMBODIMENTS

### (Underlying Knowledge Forming Basis of the Present Disclosure)

When an attack (specifically, cyberattack) is detected in an in-vehicle communication network of a vehicle, to ensure safety of a passenger of the vehicle such as a driver, an instant response as an emergency measure is needed for the purpose of preventing anomaly operation of the vehicle caused by the attack. Examples of the instant response include degeneration, vehicle control restraining, or shut-down of external communication.

The degeneration is an operation to perform emergency stop of the vehicle in a safe place such as a road shoulder by automatic control. The vehicle control restraining is a processing to restrain the control of an actuator (such as a wheel, a brake, and an accelerator) to suppress influences of anomaly operation caused by the attack. The shut-down of external communication is a processing to shut down communication between the vehicle to an external apparatus outside the vehicle through Wi-Fi (registered trademark) or mobile communication, assuming some remote fraudulent attack against the control of the vehicle from the outside of the vehicle.

However, for example, the degeneration does not block the attack itself. Thus, a similar attack may be received again when the driving is restarted. For this reason, it is afraid that the vehicle after emergency stop cannot move.

For example, the vehicle control restraining also restrains normal driving controls, and thus, it is afraid that the driver also cannot normally drive.

In such instant responses and the device disclosed in PTL 1, the attack can be avoided as an emergency measure while use of the vehicle may be impossible until a permanent measure such as analysis of vulnerability or creation of a security patch is developed. This causes troubles, for example, driving of the attacked vehicle is disabled or part of the functions cannot be used, and the vehicle should be repaired or the like in a service center using another vehicle for carrying the vehicle.

Thus, the present inventors have found a security method and the like which can quickly respond to an attack against the vehicle, even when attacked, without restricting the driving functions of the vehicle after the attack is detected.

Hereinafter, an embodiment according to the present disclosure will be specifically described with reference to the drawings.

To be noted, embodiments described below all illustrate one specific examples of the present disclosure. Numeric values, shapes, materials, components, arrangement positions of components, connection forms thereof, steps, order of steps, and the like shown in the embodiments below are exemplary, and should not be construed as limitations to the present disclosure. Moreover, among the components of the embodiments below, the components not described in an independent claim will be described as optional components.

### Embodiment

### [Configurations]

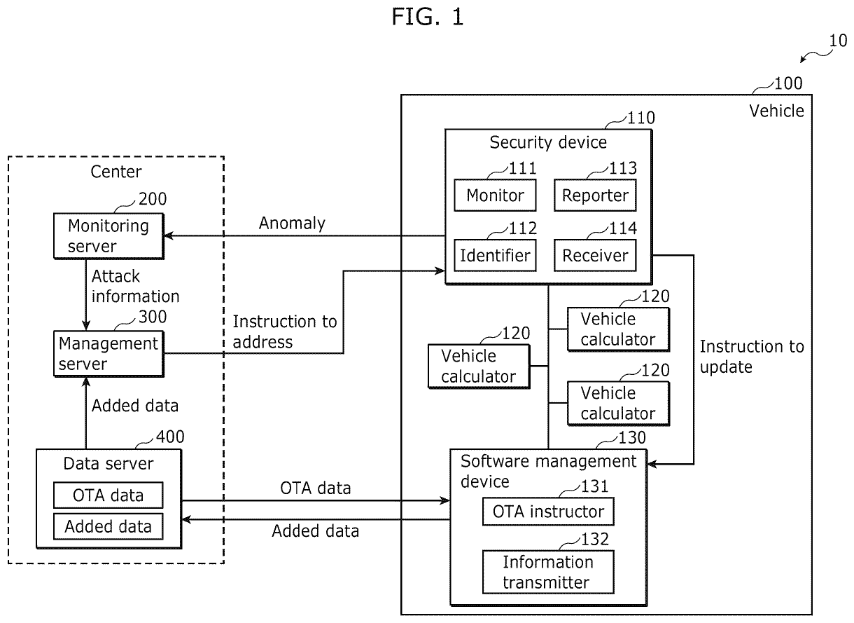

FIG. 1 is a schematic diagram of security system 10 that provides information to a vehicle, according to an embodiment.

Security system 10 is an in-vehicle communication network system including vehicle 100, monitoring server 200, management server 300, and data server 400, which are communicatively interconnected over a wireless network (e.g., a mobile communication network) such as the Internet. In security system 10, for example, vehicle 100 communicates with monitoring server 200 and management server 300 that are located in a monitoring center such as a security operation center (SOC); thus, vehicle 100 is monitored for anomalies in components of vehicle 100, including devices such as vehicle calculators 120 connected to an in-vehicle communication network, and buses connecting these devices with each other to allow their communication. Vehicle 100 also communicates with data server 400 located in the center together with monitoring server 200 and management server 300 (e.g., in a building of the monitoring center) and thus performs operations such as updating programs (software) used for control of vehicle 100.

Vehicle 100 may be any vehicle, such as a motorcycle or an automobile. In this embodiment, vehicle 100 is a self-driving vehicle having self-driving functions.

Vehicle 100 includes security device 110, vehicle calculators 120, and software management device 130.

Although FIG. 1 shows three vehicle calculators 120 in vehicle 100, vehicle 100 may include any number of vehicle calculators 120, such as one, or two or more.

As an exemplary hardware configuration, vehicle 100 includes a telematics control unit (TCU) and ECUs.

It is to be noted that vehicle 100 need not be a self-driving vehicle.

Security device 110 is a device for monitoring the state of vehicle 100. Security device 110 is communicatively connected to monitoring server 200 and management server 300.

Security device 110 obtains information (also referred to as detection information) on attacks (specifically, cyberattacks) on vehicle 100 detected in vehicle 100 and monitors the state of vehicle 100 based on the obtained detection information. Security device 110, which may be a network-based intrusion detection system (NIDS) for example, is communicatively connected to each of vehicle calculators 120 via buses and monitors data flowing through these buses. Specifically, security device 110 monitors data flowing through the buses connected to vehicle calculators 120 to detect an anomaly (in other words, an attack) occurring in vehicle 100 (more specifically, vehicle calculators 120).

Anomalies detected by security device 110 may be identified in any manner. For example, an anomaly may be detected based on no response received from vehicle calculator 120 to an inquiry made by security device 110, an unauthorized command flowing through a bus, or more than or less than a predetermined quantity of commands flowing. The predetermined quantity may be defined as appropriate. Security device 110 is communicatively connected to monitoring server 200 and outputs (transmits), to monitoring server 200, detection information (anomaly detection logs) indicating the results of anomaly detection.

The number of vehicle calculators 120 and the number of buses to which vehicle calculators 120 are connected are not limited to any particular numbers.

Security device 110 may be implemented by the following exemplary components: a TCU that includes a cellular module compliant with a mobile communication network standard for communicating with monitoring server 200 and management server 300; a communication interface for communicating with vehicle calculators 120 and software management device 130; a nonvolatile memory that stores programs; a volatile memory serving as a temporary storage area for executing programs; an input/output port for sending and receiving signals; and a processor that executes programs. A specific example of security device 110 is an ECU.

The communication interface in security device 110 may be a wired local area network (LAN) interface or a wireless LAN interface. The communication interface in security device 110 is not limited to a LAN interface and may be any communication interface capable of establishing communication connection with a communication network.

Security device 110 may also be implemented by a TCU or an ECU in vehicle 100 that performs the functions of security device 110 in addition to the original functions of the TCU or the ECU.

Security device 110 includes monitor 111, identifier 112, reporter 113, and receiver 114.

Monitor 111 is a processing unit that monitors vehicle calculators 120 for anomalies. For example, monitor 111 obtains (receives) commands flowing through the buses to which vehicle calculators 120 are connected, and determines whether the commands have an anomaly.

Identifier 112 is a processing unit that identifies vehicle calculator 120 having an anomaly. For example, in response to monitor 111 determining the occurrence of an anomaly, identifier 112 determines which vehicle calculator 120 the anomaly originates from.

For example, identifier 112 obtains, from monitor 111, information (hereinafter also referred to as an anomaly detection log) indicating that an anomalous command (hereinafter also referred to as an unauthorized controller area network (CAN) control command) is flowing through a bus in the in-vehicle communication network. Exemplary information included in the anomaly detection log is the details of the unauthorized CAN control command, and information indicating which bus the unauthorized CAN control command is flowing through of the buses constituting the in-vehicle communication network. If monitor 111 can identify vehicle calculator 120 that has sent the unauthorized CAN control command, the anomaly detection log may also include information indicating the sender vehicle calculator 120. In an example, in response to monitor 111 detecting an unauthorized CAN control command in the in-vehicle communication network, identifier 112 identifies vehicle calculator 120 that has potentially sent the unauthorized CAN control command. For example, identifier 112 identifies, based on an anomaly detection log received from monitor 111, vehicle calculator 120 that has potentially sent the unauthorized CAN control command.

Vehicle calculator 120 that has potentially sent an unauthorized CAN control command is, as an example, vehicle calculator 120 connected to a bus through which the unauthorized CAN control command is flowing. For example, security device 110 may detect that an unauthorized CAN control command is flowing through a first bus of first and second buses. Identifier 112 may then identify, as vehicle calculator 120 that has potentially sent the unauthorized CAN control command, vehicle calculator 120 connected to the first bus, among vehicle calculators 120 connected to at least one of the first and second buses.

For some types of commands, a hardware-level mechanism (e.g., Tx filtering) may be used that permits each vehicle calculator 120 to send only particular commands. In such a case, for example, identifier 112 identifies, based on the details of an unauthorized CAN control command, vehicle calculator 120 that has potentially sent the unauthorized CAN control command. Information on which commands are permitted to be sent by each vehicle calculator 120 may be stored in advance, for example in a memory in security device 110.

The number of vehicle calculators 120 identified by identifier 112 is not limited to any particular number.

Reporter 113 is a processing unit that reports the occurrence of an anomaly to monitoring server 200. For example, in response to monitor 111 determining the occurrence of an anomaly, reporter 113 outputs, to monitoring server 200, information indicating the details of the anomaly and information indicating vehicle calculator 120 identified by identifier 112.

Receiver 114 is a processing unit that obtains, from management server 300, information indicating an instruction to address an anomaly. In an example, based on the obtained information, receiver 114 outputs, to software management device 130, an instruction to update software (a program) used by vehicle calculator 120. In another example, based on the obtained information, receiver 114 causes vehicle calculator 120 to perform processing such as restricting a particular function (e.g., halting the function).

Vehicle calculators 120 are each a device that is connected to the in-vehicle communication network in vehicle 100 and controls vehicle 100. Specifically, vehicle calculators 120 control vehicle 100 using data (preinstalled apps and added data) stored in storages 126 in respective vehicle calculators 120. Vehicle calculator 120 may each be implemented by the following exemplary components: a memory that stores data such as programs; an input/output port for sending and receiving CAN control command signals to and from a TCU and other ECUs; and a processor that executes programs. Vehicle calculators 120 are each connected to the in-vehicle communication network such as a CAN via the above input/output port, thus being able to communicate over the in-vehicle communication network. Specific examples of each vehicle calculator 120 are an in-vehicle infotainment (IVI) system, an ECU, and a rear seat entertainment (RSE) system.

Vehicle calculators 120 control devices in vehicle 100, for example. Examples of the devices include an engine, a motor, meters, a transmission, a brake, a steering wheel, power windows, an air conditioner, and a car navigation system. At least one of vehicle calculators 120 is, for example, a control circuit that controls vehicle operations related to the autonomous driving of vehicle 100. In an example, vehicle calculators 120 are provided for their corresponding devices, respectively.

Each vehicle calculator 120 outputs commands for controlling the corresponding device. Examples of the commands are those compliant with a communication protocol such as CAN (CAN control commands as mentioned above).

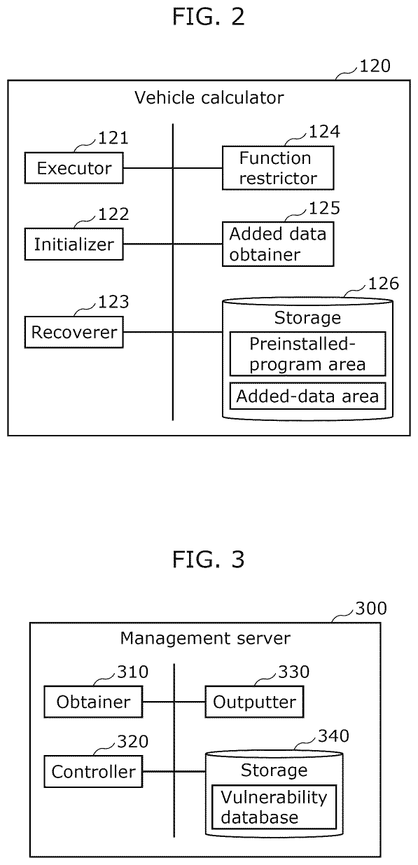

FIG. 2 is a block diagram illustrating the configuration of vehicle calculator 120 according to the embodiment.

Vehicle calculator 120 includes executor 121, initializer 122, recoverer 123, function restrictor 124, added data obtainer 125, and storage 126.

Executor 121 is a processing unit that causes initializer 122, recoverer 123, function restrictor 124, and added data obtainer 125 to execute different sorts of processing. For example, if an instruction to execute certain processing, such as restricting a particular function or updating a program, is obtained from security device 110 and/or software management device 130, executor 121 causes relevant processing units to execute the processing based on the instruction.

Initializer 122 is a processing unit that initializes data stored in storage 126. Storage 126 stores, for example, preinstalled programs stored before vehicle 100 is sold to a user, and added data installed subsequently by the user, in separate data areas. In an example, storage 126 has a preinstalled-program area and an added-data area. The preinstalled-program area stores (includes) the preinstalled programs, whereas the added-data area stores (includes) the added data. Initializer 122 initializes storage 126 (in other words, initializes data in storage 126) by, for example, deleting the added data stored in the added-data area.

Exemplary preinstalled programs are programs for vehicle 100 to perform basic operations such as driving operations. The preinstalled programs are stored in advance in storage 126, for example, by the time vehicle 100 is sold.

Exemplary added data is data stored in storage 126 after the user starts using vehicle 100. For example, the added data are setting information such as the user-configured time zone, and data such as post-installed apps added after the user starts using vehicle 100.

Recoverer 123 is a processing unit that recovers deleted added data, that is, re-stores deleted added data in storage 126, after initialization performed by initializer 122. In an example, the added data is stored in data server 400 as backup information. After initialization by initializer 122, recoverer 123 may obtain the backup information, i.e., the deleted added data, and store the obtained added data in storage 126.

Function restrictor 124 is a processing unit that restricts functions of vehicle 100. As an example, in response to obtaining an instruction to restrict a particular function from security device 110, function restrictor 124 halts part of the functions of vehicle 100 based on the instruction. As another example, in response to obtaining an instruction to lift restriction on a particular function from security device 110, function restrictor 124 causes, based on the instruction, the halted part of the functions of vehicle 100 to re-operate.

Added data obtainer 125 is a processing unit that obtains the added data stored in storage 126 and outputs the added data to software management device 130.

The time at which added data obtainer 125 obtains the added data stored in storage 126 and outputs the added data to software management device 130, and the time at which software management device 130 transfers the added data to data server 400 to be stored in data server 400, may be determined as appropriate without limitation. For example, these operations may be performed at the time of initial setup by the user, or at any time during the user's use of vehicle 100.

The processing units, including executor 121, initializer 122, recoverer 123, function restrictor 124, and added data obtainer 125, are implemented by one or more processors, for example.

Storage 126 is a memory that stores data, such as programs used by the processing units to control vehicle 100. As described above, storage 126 includes, for example, the preinstalled-program area that stores the preinstalled programs and the added-data area that stores the added data.

Storage 126 may be implemented by a single memory or multiple memories. For example, for storage 126 implemented by multiple memories, the preinstalled-program area and the added-data area may be provided in separate memories, or each memory may have the preinstalled-program area and the added-data area.

Storage 126 is implemented by a hard disk drive (HDD) or a solid-state drive (SSD), for example.

Software management device 130 is a device that updates software (e.g., preinstalled programs) used by vehicle calculators 120. Specifically, software management device 130 is communicatively connected to data server 400 and obtains the latest software from data server 400 to update software used by vehicle calculators 120 to the obtained software.

Software management device 130 includes OTA instructor 131 and information transmitter 132.

OTA instructor 131 is a processing unit that outputs, to vehicle calculators 120, instructions to update preinstalled programs. For example, if security device 110 obtains an instruction to update a preinstalled program as an instruction to address an anomaly, security device 110 outputs the instruction to update the preinstalled program to software management device 130. In response to obtaining the instruction to update the preinstalled program, OTA instructor 131 causes vehicle calculators 120 to update the preinstalled program using an update program, which is OTA data obtained from data server 400.

Information transmitter 132 is a processing unit that outputs the added data stored in storages 126 of vehicle calculators 120 to data server 400, where the added data is backed up.

Software management device 130 (specifically, OTA instructor 131 and information transmitter 132) is implemented by, for example, a TCU, an ECU, and a memory that stores programs executed by these units.

Monitoring server 200 is a computer that communicates with vehicle 100 (specifically, security device 110) to monitor the state of vehicle 100. An example of monitoring server 200 is a server used in a monitoring center such as an SOC to implement security information and event management (SIEM). Monitoring server 200 is communicatively connected to security device 110 and management server 300.

For example, in response to obtaining information indicating an anomaly from security device 110, monitoring server 200 identifies the details of an attack (also referred to as a security attack) causing the anomaly. Monitoring server 200 outputs attack information to management server 300; the attack information includes information indicating vehicle calculator 120 having the anomaly, and information indicating the details of the anomaly and the details of the attack causing the anomaly.

The details of the attack may be identified by obtaining information indicating the details of the attack from the user via a user interface such as a mouse or a keyboard, or may be identified by monitoring server 200 using means such as a database indicating the relationships between anomalies and attack details.

Monitoring server 200 may be implemented by the following exemplary components: a communication interface for communicating with security device 110 and management server 300; a nonvolatile memory that stores programs; a volatile memory serving as a temporary storage area for executing programs; an input/output port for sending and receiving signals; and a processor that executes programs.

Management server 300 is a computer for causing vehicle 100 having an anomaly to address the anomaly (specifically, an attack causing the anomaly). Management server 300 is communicatively connected to vehicle 100 (specifically, security device 110), monitoring server 200, and data server 400.

Management server 300 is an example of a security device.

Management server 300 may be implemented by the following exemplary components: a communication interface for communicating with security device 110, monitoring server 200, and data server 400; a nonvolatile memory that stores programs; a volatile memory serving as a temporary storage area for executing programs; an input/output port for sending and receiving signals; and a processor that executes programs.

FIG. 3 is a block diagram illustrating the configuration of management server 300 according to the embodiment.

Management server 300 includes obtainer 310, controller 320, outputter 330, and storage 340.

Obtainer 310 is a processing unit that obtains anomaly information.

The anomaly information is information on an anomaly caused by an attack on vehicle calculator 120. Exemplary anomaly information includes attack information that is output from monitoring server 200 to management server 300. For example, obtainer 310 obtains, as the anomaly information, the attack information from monitoring server 200.

In addition to the attack information, the anomaly information may also include related information on the anomaly, which may be output from vehicle 100 or monitoring server 200. Exemplary related information includes information indicating whether the anomaly is still occurring, added-data information obtained from the user of vehicle 100, and information on the anomaly obtained from the user of vehicle 100 or from an analyst operating management server 300.

Controller 320 is a processing unit that causes vehicle 100 to perform different sorts of processing. For example, controller 320 causes vehicle 100 to address an anomaly by causing outputter 330 to output (transmit), to vehicle 100, information indicating an instruction to take a certain action for the anomaly.

In an example, based on the anomaly information, controller 320 causes vehicle calculator 120 to delete a portion of the data in storage 126 of vehicle calculator 120 so that added data added to storage 126 after a predetermined timing is deleted.

An example of the predetermined timing is when the user of vehicle 100 starts using vehicle 100. For example, based on the anomaly information, controller 320 causes vehicle calculator 120 to delete a portion of the data in storage 126 of vehicle calculator 120; the portion to be deleted is the added data added to storage 126 after the start of the use of vehicle 100, that is, the data except the preinstalled programs stored in advance in storage 126.

The predetermined timing may be determined as appropriate. For example, added data added to storage 126 within one year of the occurrence of the anomaly may be deleted.

In an example, in response to obtainer 310 obtaining the anomaly information, controller 320 determines whether the anomaly is attributed to added data. If so, controller 320 causes the added data added to storage 126 to be deleted. Controller 320 may determine whether the anomaly is attributed to added data based on, for example, a vulnerability database stored in storage 340.

The vulnerability database is information indicating the relationships between data types and data security vulnerability. For example, controller 320 determines the vulnerability of added data based on the vulnerability database, and if the added data is determined to be vulnerable, causes the added data to be deleted.

Alternatively, controller 320 may immediately cause the added data added to storage 126 to be deleted once obtainer 310 obtains the anomaly information.

In an example, after the added data added to storage 126 is deleted, controller 320 may cause the added data to be re-stored in storage 126. For example, obtainer 310 may obtain the backed-up added data from data server 400. Controller 320 may cause the added data to be re-stored in storage 126.

In an example, after the added data added to storage 126 is deleted, controller 320 may determine whether the anomaly is attributed to the added data, and if not, cause the added data to be re-stored in storage 126. For example, controller 320 may determine the vulnerability of the added data based on the vulnerability database. For multiple pieces of added data, for example, controller 320 may cause pieces of added data involving no anomaly, e.g., pieces of added data with no vulnerability, to be re-stored in storage 126.

In an example, controller 320 identifies, based on the anomaly information, a function that has allowed the anomaly-causing attack. Controller 320 then disables the identified function, for example. Specifically, controller 320 temporarily disables the identified function.

Examples of the above function restriction include adding designation of an application to be prohibited from being installed (e.g., registering the name of the app in a denylist and/or the vulnerability database), disabling a particular communication port, and disabling a particular communication function (e.g., Wi-Fi (registered trademark) and/or Bluetooth (registered trademark)).

For example, based on the anomaly information, controller 320 determines whether added data determined to be vulnerable has been transmitted automatically from an external communication apparatus and stored in storage 126, or has been stored in storage 126 by the user's operation. As an example, if controller 320 determines that the added data determined to be vulnerable has been transmitted automatically from an external communication apparatus and stored in storage 126, controller 320 identifies a communication function of vehicle 100 as the function that has allowed the anomaly-causing attack, and temporarily disables the operation of a communication port in vehicle 100. As another example, if controller 320 determines that the added data determined to be vulnerable has been stored in storage 126 by the user's operation, controller 320 identifies an app installation function as the function that has allowed the anomaly-causing attack, and temporarily disables the app installation function.

Thus, added data that is likely to be the target of an attack can be deleted to increase the possibility of stopping an anomaly. Furthermore, a function that has allowed the attack can be halted to reduce the possibility of a further anomaly.

An anomaly may be caused by a preinstalled app and may be prevented by improving the preinstalled app. Therefore, if controller 320 obtains information indicating the completion of taking a countermeasure against an attack, for example, the completion of creating an update to a preinstalled app, controller 320 enables a function that has been halted.

The information indicating the completion of taking a countermeasure against an attack may be obtained from the user via a user interface such as the mouse or keyboard, or may be obtained (received) from data server 400. For example, if information indicating the completion of taking a countermeasure against an attack is obtained, controller 320 may cause a preinstalled program stored in storage 126 before the predetermined timing to be updated to a program enhanced with the countermeasure against the attack, and then enable a function that has been halted.

Outputter 330 is a processing unit that outputs information to vehicle 100, such as information indicating processing that controller 320 causes vehicle 100 to perform.

The processing units, including obtainer 310, controller 320, and outputter 330, are implemented by one or more processors, for example.

Storage 340 is a storage device that stores programs executed by the processing units in management server 300, and information such as the vulnerability database.

Storage 340 is implemented by an HDD or an SSD, for example.

Referring again to FIG. 1, data server 400 is an over-the-air (OTA) server that stores programs (e.g., preinstalled programs) used by vehicle calculators 120 in vehicle 100. Data server 400 also stores, as backup information, the added data used by vehicle calculators 120. Data server 400 is communicatively connected to management server 300 and vehicle 100 (specifically, software management device 130).

Data server 400 may be implemented by the following exemplary components: a communication interface for communicating with vehicle 100 and management server 300; a nonvolatile memory that stores programs; a volatile memory that servers as a temporary storage area for executing programs; an input/output port for sending and receiving signals; and a processor that executes programs.

[Procedures]

Now, procedures in security system 10 and management server 300 will be described.

### <Security System>

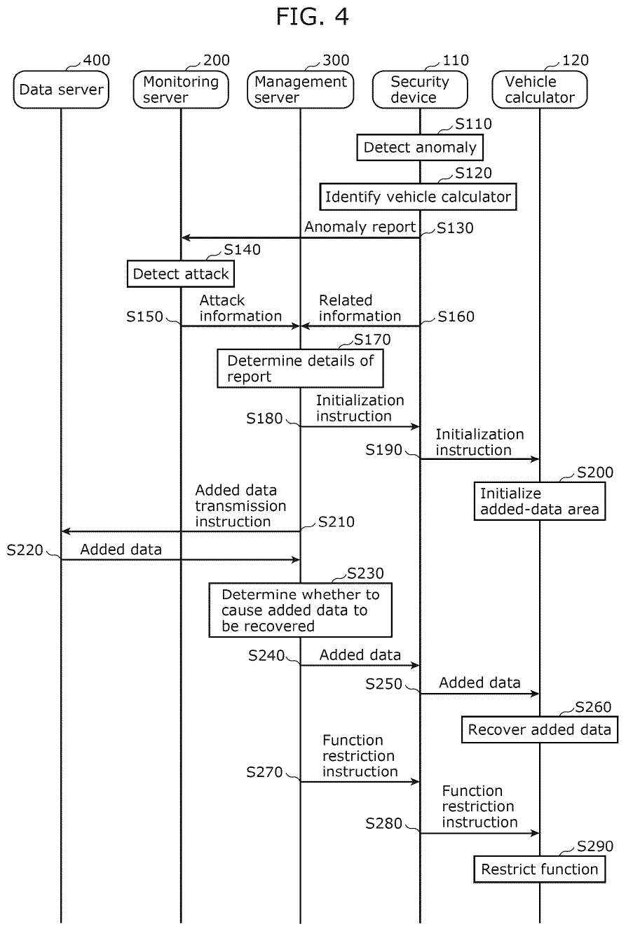

FIG. 4 is a sequence diagram illustrating the procedure of deleting added data in security system 10 according to the embodiment. Vehicle calculator 120 illustrated in FIG. 4 is one identified by security device 110 as having an anomaly among vehicle calculators 120 in vehicle 100. Although FIG. 4 shows only one vehicle calculator 120, multiple vehicle calculators 120 may be involved in the sequence. The following description of this embodiment assumes that the added data stored in storage 126 of vehicle calculator 120 is already stored in data server 400.

Security device 110 monitors the in-vehicle communication network of vehicle 100 for anomalies. If security device 110 detects an anomaly (S110), for example, detects an unauthorized CAN control command flowing in the in-vehicle communication network, security device 110 identifies, based on an anomaly detection log, vehicle calculator 120 having the anomaly among vehicle calculators 120 in vehicle 100 (S120).

Security device 110 outputs information indicating the occurrence of the anomaly (e.g., an anomaly detection log) to monitoring server 200 (S130).

In response to obtaining the information indicating the occurrence of the anomaly, monitoring server 200 detects an attack causing the anomaly (specifically, identifies the details of the attack) (S140).

Monitoring server 200 outputs, to management server 300, attack information indicating the detected attack (S150).

In an example, security device 110 may output related information on the anomaly to management server 300 (S160). For example, management server 300 obtains, as anomaly information, the attack information and the related information.

Based on the anomaly information, management server 300 determines details of report, which may indicate an instruction to be carried out by security device 110 and whether the added data is to be requested from data server 400 (S170).

Based on the determined details of report, management server 300 performs processing. In this embodiment, management server 300 performs steps S180, S210, S240, and S270. For example, management server 300 outputs, to security device 110, an initialization instruction that instructs vehicle calculator 120 to delete the added data (S180).

In response to obtaining the initialization instruction from management server 300, security device 110 outputs the initialization instruction to vehicle calculator 120 (S190). Security device 110 may simply transfer the initialization instruction obtained from management server 300 to vehicle calculator 120, or may transfer the initialization instruction after processing the initialization instruction, such as changing the format.

In response to obtaining the initialization instruction from security device 110, vehicle calculator 120 initializes the added-data area, that is, deletes the added data stored in storage 126 (S200).

Management server 300 outputs, to data server 400, an added data transmission instruction that indicates an instruction to transmit the added data deleted by vehicle calculator 120 (S210).

In response to obtaining the added data transmission instruction, data server 400 outputs the added data to management server 300 (S220).

Management server 300 determines, for example, based on the vulnerability database, whether to cause vehicle calculator 120 to recover added data, that is, to re-store added data in storage 126 (S230).

In an example, if management server 300 determines to cause vehicle calculator 120 to recover added data, management server 300 outputs the added data to security device 110 (S240). In an example, if management server 300 determines not to cause vehicle calculator 120 to recover added data, management server 300 may delete the added data without outputting the added data to security device 110. Thus, only added data determined by management server 300 to be recovered is transferred to vehicle calculator 120 and recovered.

Following step S240, in response to obtaining the added data from management server 300, security device 110 outputs the added data to vehicle calculator 120 (S250).

In response to obtaining the added data from security device 110, vehicle calculator 120 recovers the added data, that is, stores the added data in storage 126 (S260).

In an example, management server 300 outputs, to security device 110, a function restriction instruction that indicates an instruction to cause vehicle calculator 120 to restrict a certain function (S270).

In response to obtaining the function restriction instruction from management server 300, security device 110 outputs the function restriction instruction to vehicle calculator 120 (S280).

In response to obtaining the function restriction instruction from security device 110, vehicle calculator 120 restricts (disables) the certain function (S290).

The processing at steps S200, S260, and S290 may be performed only by vehicle calculator 120 identified as having an anomaly (identified as being likely to have an anomaly), or by all vehicle calculators 120.

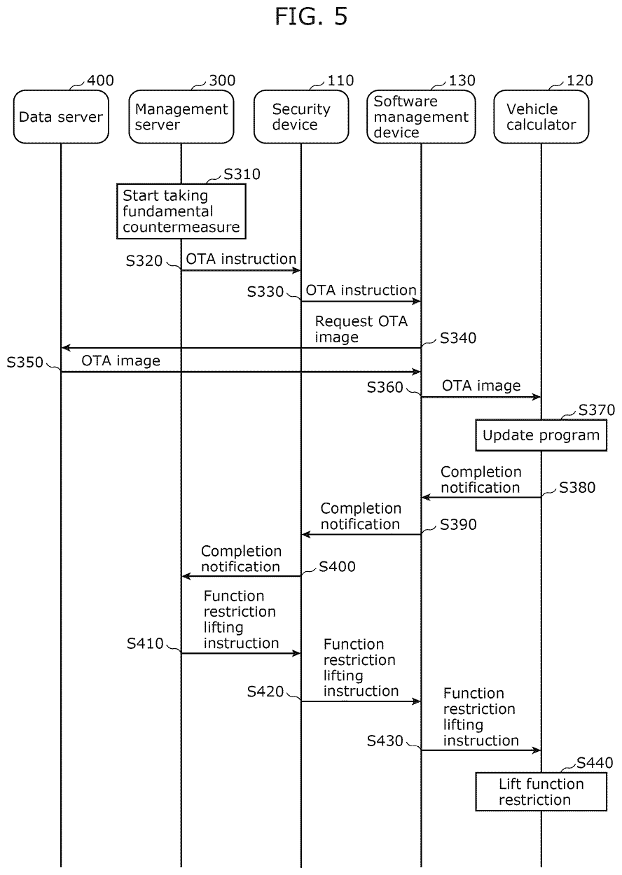

FIG. 5 is a sequence diagram illustrating the procedure of a fundamental countermeasure in security system 10 according to the embodiment. FIG. 5 illustrates an exemplary process to be performed after the process in FIG. 4.

For example, attack-resistant updated software may be created with a countermeasure against the anomaly detected at step S110 shown in FIG. 4 (i.e., a countermeasure against the attack causing the anomaly). Thus, preparation for addressing the attack causing the anomaly is started (S310). In this example, it is assumed that attack-resistant updated software enhanced with a countermeasure against the attack causing the anomaly has been created. Management server 300 transmits, to security device 110, information indicating the completion of taking the countermeasure against the attack, or in other words, information indicating the completion of preparation for addressing the anomaly (a notification of the completion of preparation for a permanent measure). In this embodiment, management server 300 outputs, to security device 110, an OTA instruction that instructs to update a program (e.g., a preinstalled program) in order to address the anomaly (S320).

In response to obtaining the OTA instruction from management server 300, security device 110 outputs the OTA instruction to software management device 130 (S330).

In response to obtaining the OTA instruction from security device 110, software management device 130 outputs, to data server 400, a request for an OTA image, which is information for updating the program (S340).

In response to obtaining the instruction to request the OTA image from software management device 130, data server 400 outputs the OTA image to software management device 130 (S350).

In response to obtaining the OTA image from data server 400, software management device 130 outputs the OTA image to vehicle calculator 120 (S360).

In response to obtaining the OTA image from software management device 130, vehicle calculator 120 uses the OTA image to update the program (S370).

Upon completion of updating the program, vehicle calculator 120 outputs, to software management device 130, a completion notification indicating the completion of the update (S380).

In response to obtaining the completion notification from vehicle calculator 120, software management device 130 outputs the completion notification to security device 110 (S390).

In response to obtaining the completion notification from software management device 130, security device 110 outputs the completion notification to management server 300 (S400).

In response to obtaining the completion notification from security device 110, management server 300 outputs, to security device 110, a function restriction lifting instruction that instructs to lift the function restriction on vehicle 100, that is, to enable the disabled function of vehicle 100 (S410).

In response to obtaining the function restriction lifting instruction from management server 300, security device 110 outputs the function restriction lifting instruction to software management device 130 (S420).

In response to obtaining the function restriction lifting instruction from security device 110, software management device 130 outputs the function restriction lifting instruction to vehicle calculator 120 (S430).

In response to obtaining the function restriction lifting instruction from software management device 130, vehicle calculator 120 lifts the function restriction on vehicle 100, that is, enables the disabled function of vehicle 100 (S440).

### <Management Server>

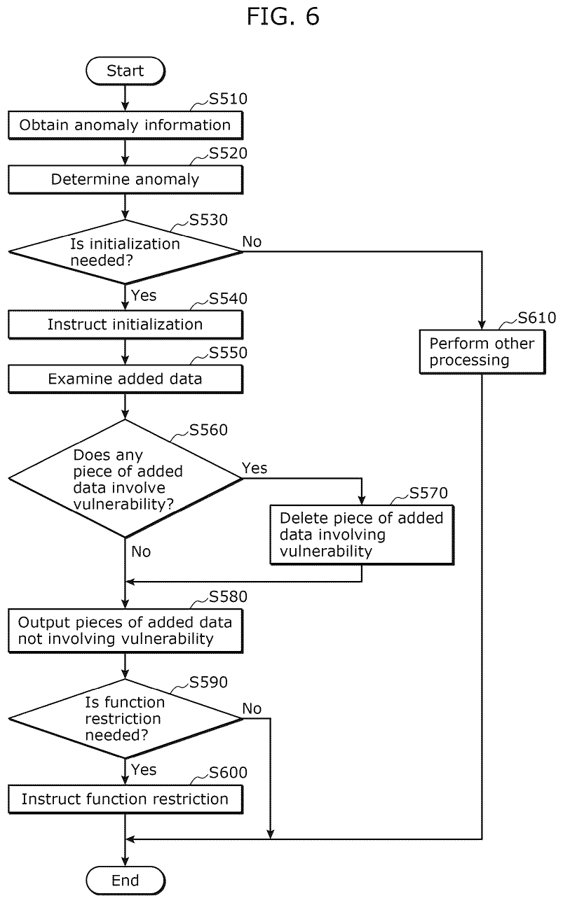

FIG. 6 is a flowchart illustrating the procedure of deleting added data in management server 300 according to the embodiment.

Obtainer 310 obtains anomaly information from an entity such as monitoring server 200 (S510).

Based on the anomaly information obtained by obtainer 310, controller 320 determines an anomaly occurring in vehicle 100 (S520). For example, based on the anomaly information, controller 320 identifies the details of the anomaly and the details of an attack.

Controller 320 determines whether storage 126 in vehicle calculator 120 needs to be initialized (S530). For example, controller 320 determines that storage 126 needs to be initialized if the anomaly is significant enough to cause vehicle 100 to malfunction.

If controller 320 determines that storage 126 needs to be initialized (Yes at S530), controller 320 causes outputter 330 to output information indicating an initialization instruction to vehicle calculator 120 via security device 110, thereby causing vehicle calculator 120 to initialize storage 126 (S540).

Controller 320 examines the added data (S550). For example, obtainer 310 obtains, from data server 400, multiple pieces of added data stored as backup information, and controller 320 matches the pieces of added data with the vulnerability database. Controller 320 thus determines, for example, whether any of the pieces of added data involves vulnerability, i.e., is vulnerable (S560).

If controller 320 determines that any of the pieces of added data involves vulnerability (Yes at S560), controller 320 deletes the piece of added data involving vulnerability (S570).

If controller 320 determines that none of the pieces of added data involves vulnerability (No at S560), or after deleting the piece of added data involving vulnerability at step S570, controller 320 causes outputter 330 to output the pieces of data not involving vulnerability to vehicle calculator 120 via security device 110, thereby causing vehicle calculator 120 to store the pieces of added data not involving vulnerability in storage 126.

If all the pieces of added data involve vulnerability, all the pieces of added data may be deleted and step S580 may be skipped. Controller 320 determines whether a function of vehicle 100 needs to be restricted (S590). For example, controller 320 determines which route has been taken by the added data determined to involve vulnerability before being stored in storage 126.

If controller 320 determines that a function of vehicle 100 needs to be restricted (Yes at S590), controller 320 causes outputter 330 to output information instructing function restriction to vehicle calculator 120 via security device 110, thereby causing vehicle calculator 120 to disable a certain function (S600). In an example, if controller 320 determines that the added data determined to be vulnerable has been transmitted automatically from an external communication device and stored in storage 126, controller 320 identifies a communication function of vehicle 100 as the function that has allowed the anomaly-causing attack, and temporarily disables the operation of a communication port of vehicle 100.

In an example, if the impact of the anomaly on the operation of vehicle 100 is insignificant, or if it is unknown which route has been taken by the added data determined to involve vulnerability before being stored in storage 126, controller 320 determines that no function of vehicle 100 needs to be restricted (No at S590) and terminates the process without instructing vehicle calculator 120 to restrict any function.

In an example, if the attack identified at step S520 seems temporary and will stop soon with little impact on the operation of vehicle 100, controller 320 determines that no initialization is needed (No at S530) and performs processing other than initialization (S610). For example, controller 320 may notify the user of the occurrence of the attack by displaying information on the attack on a display (not shown) in vehicle 100. Alternatively, the process may skip step S610 and terminate.

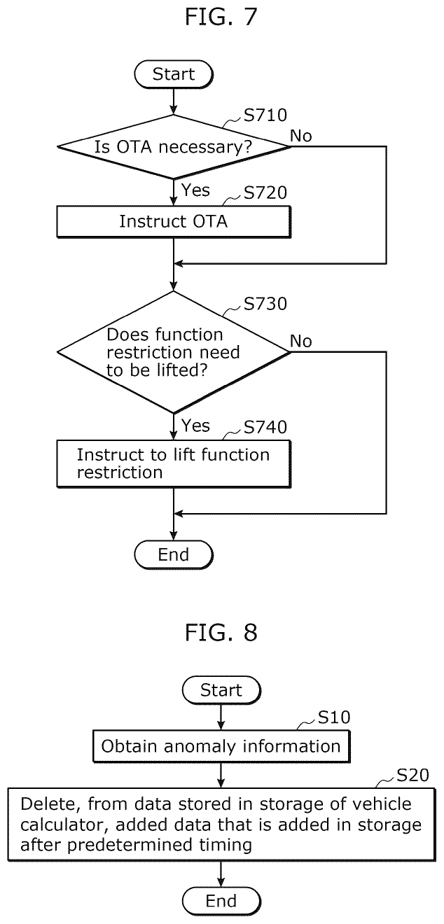

FIG. 7 is a flowchart illustrating the procedure of a fundamental countermeasure in management server 300 according to the embodiment. FIG. 7 illustrates an exemplary process to be performed after the flowchart illustrated in FIG. 6.

For example, attack-resistant updated software may be created with a countermeasure against the anomaly detected at step S110 shown in FIG. 4. Obtainer 310 may thus obtain, from data server 400, information indicating the completion of taking a countermeasure against the attack causing the anomaly. Based on this information obtained by obtainer 310, controller 320 determines whether OTA is necessary, that is, whether a program used by vehicle calculator 120 (specifically, a preinstalled program) needs to be updated (S710). For example, the information includes information indicating whether the program needs to be updated.

If controller 320 determines that OTA is necessary (Yes at S710), controller 320 causes outputter 330 to output an OTA instruction to vehicle calculator 120 via security device 110, thereby causing vehicle calculator 120 to update the program (S720).

If controller 320 determines that OTA is unnecessary (No at S710), or after step S720, controller 320 determines whether to cause vehicle 100 to lift function restriction, that is, to enable the disabled function of vehicle 100 (S730).

In an example, if function restriction is imposed on vehicle 100 and controller 320 determines that it is necessary to cause vehicle 100 to lift the function restriction (Yes at S730), controller 320 causes outputter 330 to output an instruction to lift the function restriction to vehicle calculator 120 via security device 110 (S740).

In an example, if no function restriction is imposed on vehicle 100 and controller 320 determines that it is not necessary to cause vehicle 100 to lift function restriction (No at S730), controller 320 skips step S740 and terminates the process.

FIG. 8 is a flowchart illustrating a procedure in the security device according to the embodiment. In this embodiment, FIG. 8 is a flowchart illustrating a procedure in management server 300.

First, obtainer 310 obtains anomaly information on an anomaly caused by an attack on vehicle calculator 120; vehicle calculator 120 is connected to the in-vehicle communication network in vehicle 100 and controls vehicle 100.

Based on the anomaly information, controller 320 causes vehicle calculator 120 to delete added data from storage 126 in vehicle calculator 120, the added data being a portion of data stored in storage 126 and having been added to storage 126 after a predetermined timing (S20). For example, in response to the anomaly information obtained by obtainer 310, controller 320 causes vehicle calculator 120 to delete a portion of the data in storage 126 of vehicle calculator 120; the portion to be deleted is the added data added to storage 126 after the start of the use of vehicle 100, that is, the data except the preinstalled programs stored in advance in storage 126.

### Advantageous Effects and Other Features

The following illustrates the invention provided by the disclosure in this specification, thereby describing advantageous effects and other features achieved by the illustrated invention.

Technique 1 is a security method including: obtaining anomaly information on an anomaly caused by an attack on vehicle calculator 120, vehicle calculator 120 being connected to an in-vehicle communication network in vehicle 100 and controlling vehicle 100 (S10); and causing vehicle calculator 120 to delete added data among data stored in storage 126 of vehicle calculator 120, based on the anomaly information obtained, the added data being added in storage 126 after a predetermined timing (S20).

An example of the predetermined timing is when the user of vehicle 100 starts using vehicle 100. At step S20, for example, based on the anomaly information, a portion of the data in storage 126 of vehicle calculator 120 is deleted; the portion to be deleted is the added data added to storage 126 after the start of the use of vehicle 100, that is, the data except the preinstalled programs stored in advance in storage 126.

Some types of vehicle calculators 120 such as ECUs may allow functions to be dynamically added, for example, allow the user to use data added with the user's desired timing (e.g., allow the user to install apps, as with personal computers), rather than relying on OTA. Storage 126 in such vehicle calculator 120 may be designed to have separate data areas for preinstalled programs stored in advance, for example before vehicle 100 is sold to the user, and added data installed subsequently by the user. In an example where vehicle 100 is a self-driving vehicle, programs for vehicle 100 to perform basic operations such as driving functions are stored as preinstalled programs in storage 126 in advance, such as by the time vehicle 100 is sold. In contrast, added data, including setting information such as the user-configured time zone, is stored in storage 126 after the user starts using the vehicle. It is not rare that added data having vulnerability is targeted by an attack, or an unauthorized command hides in added data. To address such cases, a security method according to Technique 1 involves deleting the added data in storage 126 if, for example, an anomaly occurs in vehicle 100. This allows deleting the added data that is likely to be the cause of the anomaly while leaving the preinstalled programs for vehicle 100 to perform the basic operations such as driving functions. Vehicle 100 can then continue performing the basic operations such as driving functions, while the occurrence of the anomaly can be stopped with high probability. Thus, the security method according to the embodiment can increase the possibility of being able to quickly address an attack on vehicle 100 without halting the basic functions of vehicle 100, while eliminating the need to update a preinstalled program to a program enhanced with a fundamental countermeasure against the attack. In other words, a provisional countermeasure taken by the SOC and/or SIEM may reduce the risk of repeated attack and/or intrusion.

The method also eliminates, for example, the need to immediately update the preinstalled program stored in storage 126, and thus eliminating the need to have an update program for the preinstalled program beforehand. This also eliminates the time required for updating the preinstalled program to use vehicle 100 after the problem arises. Thus, simply deleting the added data allows reducing the time period during which the user cannot use vehicle 100.

Technique 2 is a security method according to technique 1 which further includes: determining whether the anomaly is caused by the added data, after the obtaining of the anomaly information, wherein the causing of the vehicle calculator to delete the added data is performed when the determining is made that the anomaly is caused by the added data.

Thus, unnecessary deletion of the added data can be prevented.

Technique 3 is the security method according to technique 1 or 2 which further includes: determining whether the anomaly is caused by the causing of the vehicle calculator to delete the added data, after the causing of the vehicle calculator to delete the added data; and storing the added data again into storage 126, when the determining is made that the anomaly is not caused by the added data.

Thus, on the assumption that the cause of the anomaly may be the added data, the anomaly can be quickly addressed without requiring the time for determining the cause.

Technique 4 is the security method according to any one of techniques 1 to 3 which further includes: identifying, based on the anomaly information obtained, a function has allowed the attack causing the anomaly; and disabling the function identified.

Thus, for example, when one of the functions of vehicle 100 is anomalously operating due to the added data, the function can be halted. For example, this can reduce risks incurred by the anomaly of vehicle 100.

Technique 5 is the security method according to technique 4 which further includes: enabling the function disabled, when information indicating that a countermeasure for the attack has been performed is obtained.

Thus, the function can be prevented from being unnecessarily kept disabled.

Technique 6 is the security method according to technique 5 which further includes: updating a preinstalled program that is stored in storage 126 prior to the predetermined timing to a program for which the countermeasure for the attack has been performed, when the information indicating that the countermeasure for the attack has been performed is obtained, wherein the enabling of the function identified is performed after the updating.

This can ensure the ability of vehicle 100 to address the attack.

Technique 7 is a security device including: obtainer 310 that obtains anomaly information on an anomaly caused by an attack on vehicle calculator 120, vehicle calculator 120 being connected to an in-vehicle communication network in vehicle 100 and controlling vehicle 100; and controller 320 that causes vehicle calculator 120 to delete added data among data stored in storage 126 of vehicle calculator 120, based on the anomaly information obtained by obtainer 310, the added data that is added in storage 126 after a predetermined timing.

Management server 300 is an example of the security device.

Thus, the same advantageous effects as the security method according to the embodiment can be achieved.

These general and specific aspects may be implemented with a system, a method, an integrated circuit, a computer program, or a non-transitory recording medium such as a computer-readable CD-ROM, or with any combination of a system, a method, an integrated circuit, a computer program, and a non-transitory recording medium.

### OTHER EMBODIMENTS

Although the security device and the like according to one or more aspects have been described above based on the embodiment, the present disclosure is not limited to the above embodiment. The present disclosure also covers a variety of modifications of the embodiment conceived by persons skilled in the art without departing from the gist of the present disclosure.

As an example, monitoring server 200, management server 300, and data server 400 may be located in the same building or in different buildings. The functions of monitoring server 200, management server 300, and data server 400 may be implemented by, for example, one or more computers, and the functions may be performed by any of the one or more computers.

As another example, the functions performed by monitoring server 200 and management server 300 may be included in vehicle 100. For example, if vehicle 100 obtains anomaly information, i.e., detects an anomaly, vehicle 100 may delete the added data stored in storage 126, that is, the data except the preinstalled programs.

Moreover, for example, in the above embodiment, processing executed by a specific processor may be executed by another processor. Moreover, order of a plurality of processes may be changed, or a plurality of processes may be executed in parallel.

Moreover, for example, in the above embodiment, the components of the processors may be configured with dedicated hardware, or may be implemented by executing software programs suitable for the components. The components may be implemented by a program executor, such as a CPU or a processor, which reads out and executes software programs recorded in a recording medium such as a hard disk or a semiconductor memory.

The present disclosure also covers the following cases.

(1) At least one device above is specifically a computer system configured with a microprocessor, a ROM, a RAM, a hard disk unit, a display unit, a keyboard, a mouse, and the like. The RAM or the hard disk unit stores a computer program. The microprocessor operates according to the computer program, and thereby, the at least one device achieves the function. Here, the computer program is configured with a combination of command codes indicating instructions to the computer to achieve predetermined functions.

(2) Part or all of the components constituting at least one device above may be configured with a single system large scale integration (LSI: large scale integrated circuit). The system LSI is an ultra multi-function LSI manufactured by integrating a plurality of components on a single chip, and is specifically a computer system configured with a microprocessor, a ROM, a RAM, and the like. The RAM stores a computer program. The microprocessor operates according to the computer program, and thereby, the system LSI achieves the function.

(3) Part or all of the components constituting at least one device above may be configured with an IC card or single module detachably attachable to the device. The IC card or the module is a computer system configured with a microprocessor, a ROM, a RAM, and the like. The IC card or the module may include the ultra multi-function LSI above. The microprocessor operates according to the computer program, and thereby, the IC card or the module achieves the function. This IC card or module may have tamper proofness.

(4) The present disclosure may be the method illustrated above. Alternatively, the present disclosure may be a computer program for causing a computer to implement these methods, or may be digital signals generated by the computer program.

Alternatively, the present disclosure may be a computer program or digital signals recorded on a computer-readable recording medium, such as a flexible disc, a hard disk, a compact disc (CD)-ROM, a DVD, a DVD-ROM, a DVD-RAM, a Blu-ray (registered trademark) Disc) (BD), or a semiconductor memory. Alternatively, the present disclosure may be digital signals recorded on these recording media.

Alternatively, the present disclosure may be a computer program or digital signals transmitted through an electrical communication line, a wireless or wired communication line, a network such as the Internet, or data broadcasting.

Alternatively, the present disclosure may be implemented by another independent computer system by recording a program or digital signals on a recording medium and transporting the recording medium or by transporting the program or digital signals through a network or the like.

### Further Information about Technical Background to this Application

The disclosures of the following patent applications including specification, drawings, and claims are incorporated herein by reference in their entirety: Japanese Patent Application No. 2022-196075 filed on Dec. 8, 2022, and PCT International Application No. PCT/JP2023/032837 filed on Sep. 8, 2023.

### INDUSTRIAL APPLICABILITY

The present disclosure is applicable to security devices and the like that monitor in-vehicle communication networks for cyberattacks.

1. A security method comprising:
obtaining anomaly information on an anomaly caused by an attack on a vehicle calculator, the vehicle calculator being connected to an in-vehicle communication network in a vehicle and controlling the vehicle; and
causing the vehicle calculator to delete added data among data stored in a storage of the vehicle calculator, based on the anomaly information obtained, the added data being added in the storage after a predetermined timing.

2. The security method according to claim 1, further comprising:
determining whether the anomaly is caused by the added data, after the obtaining of the anomaly information, wherein
the causing of the vehicle calculator to delete the added data is performed when the determining is made that the anomaly is caused by the added data.

3. The security method according to claim 1, further comprising:
determining whether the anomaly is caused by the causing of the vehicle calculator to delete the added data, after the causing of the vehicle calculator to delete the added data; and
storing the added data again into the storage, when the determining is made that the anomaly is not caused by the added data.

4. The security method according to claim 1, further comprising:
identifying, based on the anomaly information obtained, a function that has allowed the attack causing the anomaly; and
disabling the function identified.

5. The security method according to claim 4, further comprising:
enabling the function disabled, when information indicating that a countermeasure for the attack has been performed is obtained.

6. The security method according to claim 5, further comprising:
updating a preinstalled program that is stored in the storage prior to the predetermined timing to a program for which the countermeasure for the attack has been performed, when the information indicating that the countermeasure for the attack has been performed is obtained, wherein
the enabling of the function identified is performed after the updating.

7. A security device comprising:
an obtainment circuit that obtains anomaly information on an anomaly caused by an attack on a vehicle calculator, the vehicle calculator being connected to an in-vehicle communication network in a vehicle and controlling the vehicle; and
a control circuit that causes the vehicle calculator to delete added data among data stored in a storage of the vehicle calculator, based on the anomaly information obtained by the obtainment circuit, the added data being added in the storage after a predetermined timing.
